(19) United States
(12) Patent Application Publication
(10) Pub. No.: US 2013/0061716 A1
(43) Pub. Date: Mar. 14, 2013

(54) VEHICULAR STARTER RING GEAR

(71) Applicants: Motoaki Kamimura, Toyota-shi (JP); Kiichiro Tanaka, Miyoshi-shi (JP); Satoru Nakamura, Toyota-shi (JP)

(72) Inventors: Motoaki Kamimura, Toyota-shi (JP); Kiichiro Tanaka, Miyoshi-shi (JP); Satoru Nakamura, Toyota-shi (JP)

(21) Appl. No.: 13/701,037

(22) PCT Filed: Aug. 9, 2010
(86) PCT No.: PCT/JP2010/063509

§ 371 Date: Nov. 30, 2012

(30) Foreign Application Priority Data
Jun. 1, 2010 (JP) 2010-126236

(51) Int. Cl. F02N 11/00

(52) U.S. Cl. CPC F02N 11/00
USPC 74/7 E

(57) ABSTRACT

A vehicular starter ring gear in the form of an annular member which has external teeth and which is welded at a plurality of positions to a disc member rotated with an engine, such that the vehicular starter ring gear is fitted on an outer circumferential surface of the disc member, so that the vehicular starter ring gear is rotated to start the engine, by a starter motor having a pinion gear engageable with the external teeth, includes: a thermal resistor portion provided in a radial portion between an inner circumferential surface and peak surfaces of the external teeth, and radially outwardly of at least welding portions bridging the vehicular starter ring gear and the disc member, the thermal resistor portion restraining conduction of a heat generated during an operation to form the welding portions, to the external teeth.

### CROSS-REFERENCE TO RELATED APPLICATIONS

This application is a national phase application of International Application No. PCT/JP2010/063509, filed Aug. 9, 2010, and claims the priority of Japanese Application No. 2010-126236, filed Jun. 1, 2010, the content of both of which is incorporated herein by reference.

### TECHNICAL FIELD

The present invention relates to a vehicular starter ring gear used for starting an engine, and more particularly to techniques for restraining reduction of hardness of external teeth of the vehicular starter ring gear.

### BACKGROUND ART

There is known a vehicular starter ring gear in the form of an annular member which has external teeth and which is welded at a plurality of positions to a disc member rotated with an engine, such that the vehicular starter ring gear is fitted on an outer circumferential surface of the disc member, so that the vehicular starter ring gear is rotated to start the above-described engine, by a starter motor having a pinion gear engageable with the above-described external teeth. Examples of such a vehicular starter ring gear are disclosed in Patent Documents 1 and 2. The starter ring gear disclosed in Patent Document 1 is welded to a covering member of a torque converter, which serves as the disc member rotated with the engine. The starter ring gear disclosed in Patent Document 2 is welded to a circular driving plate provided as the disc member rotated with the engine, and the driving plate is fixed to a covering member of a torque converter.

For example, the vehicular starter ring gear described above is manufactured by bending a drawn rod member into an annular shape, butt-welding the rod member at its opposite end faces so as to form an annular member, forming external teeth on an outer circumferential surface of the annular member by using a tooth cutting tool such as a hob, and subjecting the external teeth to a high-frequency or induction hardening treatment or a carburizing treatment.

### PRIOR ART DOCUMENTS

### Patent Documents

Patent Document 1: JP-11-13852 A

Patent Document 2: JP-3-99788 A

### SUMMARY OF THE INVENTION

### Object Achieved by the Invention

The above-indicated conventional vehicular starter ring gear manufactured as described above is fitted on the outer circumferential surface of the above-described disc member and welded to the disc member at a plurality of welding positions. During the welding operation, a welding heat is conducted to the external teeth at or near the welding positions, with a result of annealing of some in the circumferential direction of these external teeth, giving rise to a problem of hardness reduction of the some of the external teeth in question, and a consequent problem of circumferentially local wearing of the external teeth due to meshing engagement with the above-described pinion gear.

The present invention was made in view of the background art described above. It is therefore an object of the present invention to provide a vehicular starter ring gear configured to restrain the hardness reduction of its external teeth caused by an operation of welding to the disc member.

### Means for Achieving the Object

The object indicated above is achieved according to the first aspect of the present invention, which provides (a) a vehicular starter ring gear in the form of an annular member which has external teeth and which is welded at a plurality of positions to a disc member rotated with an engine, such that the vehicular starter ring gear is fitted on an outer circumferential surface of the disc member, so that the vehicular starter ring gear is rotated to start the above-described engine, by a starter motor having a pinion gear engageable with the above-described external teeth, (b) comprising a thermal resistor portion provided in a radial portion between an inner circumferential surface and peak surfaces of the above-described external teeth of the vehicular starter ring gear, and radially outwardly of at least welding portions between the above-described vehicular starter ring gear and the above-described disc member, the thermal resistor portion restraining conduction of a heat generated during an operation to form the welding portions, to the above-described external teeth.

According to the second aspect of the invention depending from the first aspect, the above-described thermal resistor portion consists of an arcuate groove formed in a side surface of the above-described vehicular starter ring gear, so as to extend in a circumferential direction of the vehicular starter ring gear, or a straight groove formed in the side surface, so as to extend in a tangential direction of the vehicular starter ring gear.

According to the third aspect of the invention depending from the first aspect, the above-described thermal resistor portion consists of an annular groove formed in a side surface of the above-described vehicular starter ring gear, continuously over an entire circumference of the vehicular starter ring gear.

According to the fourth aspect of the invention depending from the first aspect, the above-described thermal resistor portion consists of a through-hole formed between opposite side surfaces of the above-described vehicular starter ring gear.

According to the fifth aspect of the invention depending from the second or third aspect, (a) the above-described pinion gear is movable in a direction parallel to an axis of rotation of the above-described vehicular starter ring gear, between a meshing position for meshing engagement with the above-described vehicular starter ring gear, and a non-meshing position for disengagement from the above-described vehicular starter ring gear, and is moved to the above-described meshing position when the above-described vehicular starter ring gear is rotated by the above-described starter motor, and to the above-described non-meshing position when the above-described vehicular starter ring gear is not rotated by the above-described starter motor, and (b) the above-described thermal resistor portion is formed in one side surface of the above-described vehicular starter ring gear which faces toward the above-described pinion gear placed in the above-described non-meshing position, in the direction parallel to the above-described axis of rotation, and on which the vehicular starter ring gear is welded to the above-described disc member.

According to the sixth aspect of the invention depending from any one of the first to fifth aspects, the above-described vehicular starter ring gear is rotated by the above-described starter motor to re-start the above-described engine, upon implementation of an automatic engine stop/start control wherein the above-described engine is automatically temporarily stopped when a running of a vehicle is stopped, and is re-started when the running of the vehicle is re-started.

### Advantages of the Invention

The vehicular starter ring gear according to the first aspect of the invention has the thermal resistor portion formed in a radial portion between the inner circumferential surface and the peak surfaces of the external teeth, and radially outwardly of at least the welding portions between the vehicular starter ring gear and the disc member, so that the thermal resistor portion restrains the conduction of the heat generated during a welding operation to form the welding portions, to the external teeth. When the vehicular starter ring gear the external teeth of which are hardened by an induction or carburizing hardening treatment is welded to the disc member such that the starter ring gear is fitted on the outer circumferential surface of the disc member, the thermal resistor portion restrains the conduction of the heat generated during welding to the disc member, to the external teeth, and accordingly restrains the degree of annealing of the external teeth by the heat conducted thereto, making it possible to restrain reduction of the hardness of the external teeth, which is caused by the welding to the disc member. Accordingly, the provision of the thermal resistor portion makes it possible to restrain circumferentially local wearing of the external teeth due to meshing engagement with the above-described pinion gear.

In the vehicular starter ring gear according to the second aspect of the invention, the above-described thermal resistor portion consists of arcuate grooves formed in the side surface of the above-described vehicular starter ring gear, so as to extend in a circumferential direction, or straight grooves formed in the side surface, so as to extend in a tangential direction. In the presence of the arcuate or straight grooves located radially outwardly of the welding portions between the vehicular starter ring gear and the disc member, the heat generated during the operation to form the above-indicated welding portions is less likely to be conducted or transferred from the welding portions to the external teeth, than in the absence of those grooves, so that the degree of annealing of the external teeth by the heat conducted thereto can be restrained, and the hardness reduction of the external teeth can be restrained.

In the vehicular starter ring gear according to the third aspect of the invention, the above-described thermal resistor portion consists of an annular groove formed in a side surface of the above-described vehicular starter ring gear, continuously over an entire circumference of the vehicular starter ring gear. In the presence of the annular groove formed radially outwardly of the welding portions between the vehicular starter ring gear and the disc member, the heat generated during the operation to form the above-indicated welding portions is less likely to be conducted or transferred from the welding portions to the external teeth, than in the absence of the annular groove, so that the degree of annealing of the external teeth by the heat conducted thereto can be restrained, and the hardness reduction of the external teeth can be restrained. Further, the annular groove formed continuously over the entire circumference of the starter ring gear is advantageously easier to be cut than the arcuate grooves formed over respective circumferential portions of the starter ring gear, so that the starter ring gear can be manufactured at a reduced cost. It is also noted that the vehicular starter ring gear having the arcuate grooves as the thermal resistor portion must be positioned in its circumferential direction such that the arcuate grooves are aligned with the respective welding portions to be formed between the vehicular starter ring gear and the disc member, in the circumferential direction of the starter ring gear, when the starter ring gear is fitted on the outer circumferential surface of the disc member, or alternatively, the vehicular starter ring gear and the disc member must be welded together, at their circumferential portions or positions aligned with the respective arcuate grooves in the circumferential direction. However, the vehicular starter ring gear having the annular groove as the thermal resistor portion does not require the above-described positioning upon the welding operation or the determination of the welding positions, so that the number of steps required to manufacture the starter ring gear is reduced, and the cost of manufacture of the starter ring gear can be accordingly reduced.

In the vehicular starter ring gear according to the fourth aspect of the invention, the above-described thermal resistor portion consists of through-holes formed between opposite surfaces of the above-described vehicular starter ring gear. In the presence of the through-holes formed radially outwardly of the welding portions between the vehicular starter ring gear and the disc member, the heat generated during the operation to form the above-indicated welding portions is less likely to be conducted or transferred from the welding portions to the external teeth, than in the absence of the through-holes, so that the degree of annealing of the external teeth by the heat conducted thereto can be restrained, and the hardness reduction of the external teeth can be restrained.

In the vehicular starter ring gear according to the fifth aspect of the invention, the above-described pinion gear is movable in a direction parallel to an axis of rotation of the above-described vehicular starter ring gear, between a meshing position for meshing engagement with the above-described vehicular starter ring gear, and a non-meshing position for disengagement from the above-described vehicular starter ring gear, and is moved to the above-described meshing position when the above-described vehicular starter ring gear is rotated by the above-described starter motor, and to the above-described non-meshing position when the above-described vehicular starter ring gear is not rotated by the above-described starter motor, and the above-described thermal resistor portion is formed in one side surface of the above-described vehicular starter ring gear which faces toward the above-described pinion gear placed in the above-described non-meshing position, in the direction parallel to the above-described axis of rotation, and on which the vehicular starter ring gear is welded to the above-described disc member. Accordingly, the thermal resistor portion can restrain conduction of the heat generated during welding between the vehicular starter ring gear and the disc member, particularly to those parts of the external teeth of the vehicular starter ring gear which parts are located on the side of the above-indicated one side surface and which contact with the pinion gear moved from the non-meshing position to the meshing position, so that the thermal resistor portion can restrain hardness reduction of the above-indicated parts of the external teeth of the vehicular starter ring gear, on the side of the above-indicated one side surface, which parts are particularly required to have a high degree of hardness.

In the vehicular starter ring gear according to the sixth aspect of the invention, the vehicular starter ring gear is rotated by the above-described starter motor to re-start the above-described engine, upon implementation of an automatic engine stop/start control wherein the above-described engine is automatically temporarily stopped when a running of a vehicle is stopped, and is re-started when the running of the vehicle is re-started. As a result of implementation of this automatic engine stop/start control, the frequency of engine starting operations is made considerably higher, than in the case where the automatic engine stop/start control is not implemented, so that the starter ring gear is required to have an accordingly increased degree of durability. In this respect, a comparatively simple modification of the starter ring gear so as to form the thermal resistor portion radially outwardly of its welding portions makes it possible to increase the durability of the external teeth of the starter ring gear.

### BRIEF DESCRIPTION OF THE DRAWINGS

FIG. 1 is a schematic view showing arrangements of an engine and a power transmitting system of a vehicle to which the present invention is applicable;

FIG. 2 is a block diagram for explaining major portions of a control system provided on the vehicle to control the engine and power transmitting system of FIG. 1;

FIG. 3 is a cross sectional view showing a torque converter including a starter ring gear shown in FIG. 1, and a part of a crankshaft;

FIG. 4 is a view showing only the starter ring gear and a driving plate as seen in a direction of an arrow IV in FIG. 3;

FIG. 5 is a cross sectional view taken along line V-V in FIG. 4

FIG. 6 is a view indicating relationships between a hardness value of the starter ring gear and a distance in the radial direction toward center from peak surfaces of external teeth of the starter ring gear at a position in its direction of thickness 0.5mm spaced from one of its opposite side surfaces, at respective predetermined circumferential positions of the starter ring gear;

FIG. 7 is a view corresponding to that of FIG. 4 showing a first embodiment, and showing a starter ring gear according to another embodiment of the invention, and the driving plate;

FIG. 8 is a view corresponding to that of FIG. 5 showing the first embodiment, and showing a starter ring gear according to a further embodiment of the invention, and the driving plate;

FIG. 9 is a view corresponding to that of FIG. 3 showing the first embodiment, and showing a starter ring gear according to a still further embodiment of the invention, and the driving plate;

FIG. 10 is a view showing circumferential portions of a starter ring gear according to a yet further embodiment of the invention, and the driving plate; and

FIG. 11 is a view indicating relationships between a hardness value of a prior art starter ring gear and a distance in the radial direction toward center from peak surfaces of external teeth of the prior art starter ring gear at a position in its direction of thickness 0.5mm spaced from one of its opposite side surfaces, at each of predetermined circumferential positions of the prior art starter ring gear, the prior art starter gear being identical with the starter ring gear according to the first embodiment, except for absence of a plurality of arcuate grooves provided in the first embodiment.

### MODE FOR CARRYING OUT THE INVENTION

Embodiments of the present invention will be described in detail by reference to the drawings. It is to be understood that the drawings showing the embodiments are simplified or transformed as needed, and do not necessarily accurately indicate the dimensions, shapes and the like of individual elements of the embodiments.

### First Embodiment

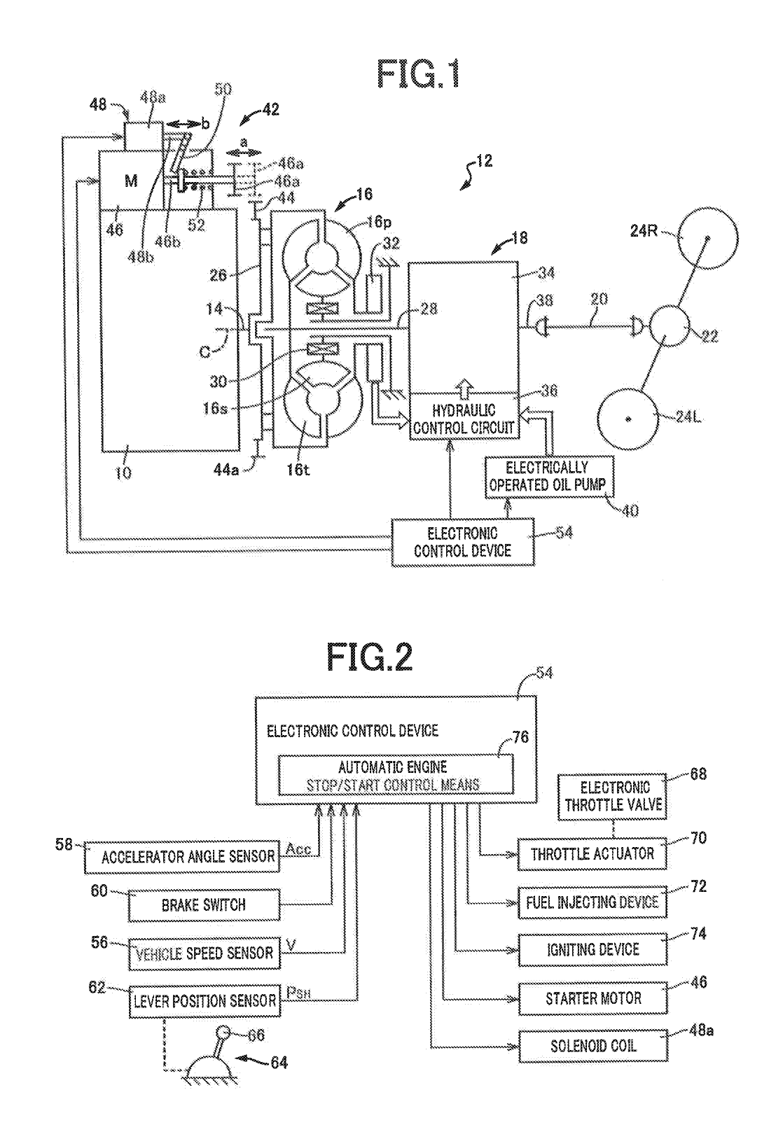

FIG. 1 is the schematic view showing the arrangements of an engine 10 and a power transmitting system 12 of a vehicle to which the present invention is applicable. These engine 10 and power transmitting system 12 are suitably used for a FR (front-engine rear-drive) vehicle. An output of the engine 10 in the form of an internal combustion engine serving as a vehicle drive power source is transmitted from a crankshaft 14 of the engine 10 to a differential gear device 22 through a torque converter 16, an automatic transmission 18 and a propeller shaft 20, and is distributed from the differential gear device 22 to left and right drive wheels 24L, 24R.

The torque converter 16 is provided with: a pump impeller 16p connected to the crankshaft 14 through a driving plate 26 in the form of a disc; a turbine impeller 16t connected to an input shaft 28 of the automatic transmission 18; and a stator impeller 16s which is prevented by an one-way clutch 30 from rotating in one direction. The torque converter 16 is a well known fluid-type power transmitting device wherein a rotary motion of the pump impeller 16p rotated with the crankshaft 14 is transmitted to the turbine impeller 16t through a working fluid circulated within the torque converter 16 by the pump impeller 16p. To the pump impeller 16p, there is connected a drive shaft of a mechanically operated oil pump 32, so that this oil pump 32 is operated by the engine 10. It will be understood that the above-indicated driving plate 26 corresponds to a disc member rotated with the engine of the present invention.

The automatic transmission 18 is principally constituted by a transmission mechanism 34 having a plurality of planetary gear sets and a plurality of hydraulically operated coupling devices such as clutches and brakes, and a hydraulic control circuit 36 for controlling hydraulic pressures to be applied to the above-indicated hydraulically operated coupling devices, for switching these coupling devices between engaged and released states. The automatic transmission 18 is a well known planetary gear type transmission which is shifted to select one of a plurality of predetermined speed ratios, depending upon a running state of the vehicle. The speed ratios are defined as ratios of a rotating speed of the input shaft 28 to a rotating speed of an output shaft 38. The power transmitting system 12 is provided with the above-indicated mechanically operated oil pump 32, and an electrically operated oil pump 40 which is not operated by the engine 10 but is operated with an electric energy supplied from a battery not shown. The above-indicated hydraulic control circuit 36 is supplied with a pressurized working oil from the mechanically operated oil pump 32 or the electrically operated oil pump 40, and the pressure of the pressurized working oil is regulated by the hydraulic control circuit 36 to a hydraulic pressure to be applied to each of the above-indicated hydraulically operated coupling devices.

The power transmitting system 12 is further provided with an engine starting device 42 for starting the engine 10, that is, for assisting the engine 10 until the engine 10 is operated by itself. This engine starting device 42 is provided with: a starter ring gear 44 in the form of an annular member which has external teeth 44a and which is fixedly fitted on an outer circumferential surface of the driving plate 26; a starter motor 46 which has a pinion gear 46a engageable with the external teeth 44a to rotate the starter ring gear 44; and a magnet switch 48 provided to move the pinion gear 46a between a meshing position for meshing engagement with the starter ring gear 44, and a non-meshing position for disengagement from the starter ring gear 44. It is noted that the pinion gear 46a indicated by broken lines in FIG. 1 is placed in the meshing position for engagement with the starter ring gear 44, while the pinion gear 46a indicated by solid lines in FIG. 1 is placed in the non-meshing position for disengagement from the starter ring gear 44.

The above-indicated starter motor 46 has an output shaft 46b movable in an axial direction parallel to a rotation axis C of the starter ring gear 44, as indicated by an arrow “a” in FIG. 1, and the above-indicated pinion gear 46a fixed to an end portion of the output shaft 46b. The above-indicated magnet switch 48 has a solenoid 48a, and an iron core 48b which is movable in a direction parallel to the output shaft 46a, as indicated by an arrow “b” in FIG. 1, such that the iron core 48b is moved toward the solenoid 48a when the solenoid 48a is energized.

When the starter ring gear 44 is rotated by the starter motor 46, the solenoid 48a is energized to move the iron core 48b toward the solenoid 48a, so that the output shaft 46b is moved by the iron core 48b, in the axial direction toward the starter ring gear 44, through a lever member 50, whereby the pinion gear 46a is moved to its meshing position for meshing engagement with the starter ring gear 44, as indicated by the broke lines in FIG. 1. As a result, the starter ring gear 44 is rotated with an output torque of the starter motor 46 transmitted thereto through the pinion gear 46a placed in the above-indicated meshing position.

While the starter ring gear 44 is not rotated by the starter motor 46, the solenoid 48a is de-energized so that the output shaft 46b is moved under a biasing force of a spring 52, in the axial direction away from the starter ring gear 44, whereby the pinion gear 46a is moved to its non-meshing position for disengagement from the starter ring gear 44, as indicated by the solid lines in FIG. 1.

The engine starting device 42 constructed as described above is configured to rotate the crankshaft 14 through the pinion gear 46a and the ring gear 44 by operating the starter motor 46, for raising the operating speed of the engine 10 to a predetermined engine ignition value at which the engine 10 can be started.

FIG. 2 is the block diagram for explaining major portions of a control system provided on the vehicle to control the engine 10 and power transmitting system 12 shown in FIG. 1. An electronic control device 54 shown in FIG. 2 is principally constituted by a so-called “microcomputer” incorporating a CPU, a RAM, a ROM and an input-output interface, for example. The CPU operates to perform signal processing operations according to programs stored in the ROM, while utilizing a temporary data storage function of the RAM, for implementing an output control of the engine 10, a shifting control of the automatic transmission 18, and an operation control of the engine starting device 42.

The electronic control device 54 is configured to receive input signals including: a vehicle speed signal indicative of a running speed V of the vehicle detected by a vehicle speed sensor 56; an accelerator angle signal indicative of an operating amount of an accelerator pedal, namely, an accelerator angle Acc detected by an accelerator angle sensor 58; a brake operation signal indicating presence of a depressing operation of a brake pedal detected by a brake switch 60; and a shift position signal indicative of a selected one of operating positions P_{SH} of a shift lever 66 of a manual shifting device 64 detected by a lever position sensor 62. The above-indicated manual shifting device 64 is provided with the shift lever 66 which is manually operable by the vehicle operator to the selected one of the plurality of predetermined operating positions P_{SH}, to change an operating state of the automatic transmission 18. The above-indicated shift lever 66 is operable to one of a parking position for cutting off a power transmitting path through the automatic transmission 18, and locking the output shaft 38 of the automatic transmission 18; a reverse drive position for placing the automatic transmission 18 in a reverse drive gear position; a neutral position for cutting off the power transmitting path through the automatic transmission 18; and a forward drive position for automatically shifting the automatic transmission 18 within a D range in which a plurality of forward drive gear positions are selectively established.

On the other hand, the electronic control device 54 is configured to generate engine output control command signals for controlling the output of the engine 10, such as: a throttle signal for operating a throttle actuator 70 to open and close an electronic throttle valve 68; a fuel injection signal for controlling an amount of injection of a fuel from a fuel injecting device 72; and an ignition timing signal for controlling a timing of ignition of the engine 10 by an igniting device 74. The electronic control device 54 is also configured to generate other output signals including: signals for controlling the hydraulic control circuit 36 to shift the automatic transmission 18; a signal for operating the starter motor 46; and a signal for energizing the solenoid 48a of the magnet switch 48 to move the pinion gear 46a of the starter motor 46 to its meshing position for meshing engagement with the starter ring gear 44.

The electronic control device 54 has control functions including a function to be performed by automatic engine stop/start control means 76, which will be described in detail. This automatic engine stop/start control means 76 is configured to implement an automatic engine stop/start control wherein the engine 10 is automatically temporarily stopped when a running of the vehicle is stopped, and is re-started by operating the starter motor 46 of the engine starting device 42 to rotate the starter ring gear 44 when the running of the vehicle is re-started. The automatic engine stop/start control described above is also called “an eco-run control (economy running control)” or “idling stop control”. For instance, the automatic engine stop/start control means 76 implements a control to close the electronic throttle valve 68 by the throttle actuator 70, and a control to stop a fuel supply from the fuel injecting device 72, for automatically and temporarily stopping the engine 10, if a predetermined engine stopping condition is satisfied upon stopping of the vehicle running such as at a traffic signal, for the purpose of improving the fuel economy, and reducing exhaust emissions, noises of the vehicle, and the like. The automatic engine stop/start control means 76 starts the engine 10 by the engine starting device 46 if a predetermined engine starting condition is satisfied.

For example, the above-indicated predetermined engine stopping condition in the present embodiment is a condition in which the automatic transmission 18 is placed in the forward driving state in which the automatic transmission 18 is automatically shifted within the D range, and the accelerator angle Acc is zero, while the foot brake is operated, with the vehicle speed V being zero. For example, the above-indicated predetermined engine starting condition in the present embodiment is a condition in which the vehicle operator has performed a manual operation with the intention of starting the vehicle, for instance, a releasing operation of the foot brake, or an operation of the accelerator pedal to increase the accelerator angle Acc from zero.

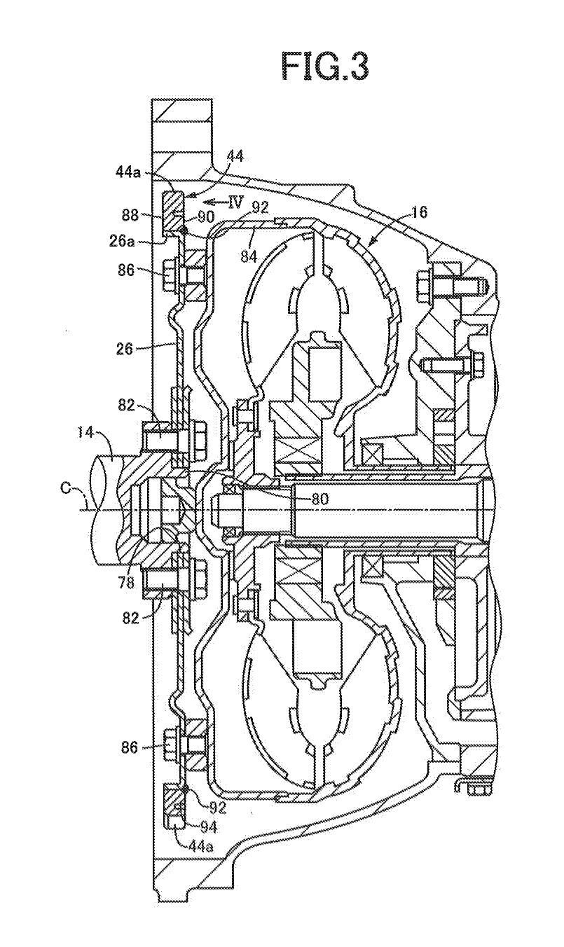

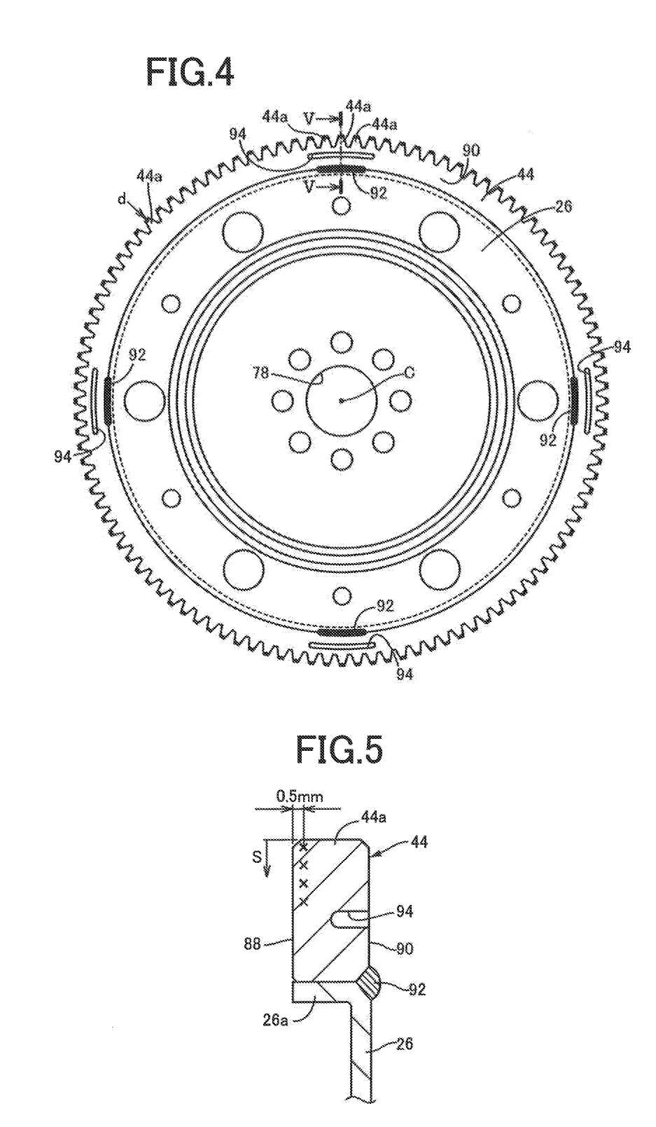

Then, the starter ring gear 44 provided in the first embodiment of the invention will be described in detail. FIG. 3 is the cross sectional view showing the torque converter 16 including the starter ring gear 44, and a part of the crankshaft 14, and FIG. 4 is the view showing only the starter ring gear 44 and the driving plate 26 as seen in the direction of an arrow IV in FIG. 3, while FIG. 5 is the cross sectional view taken along line V-V in FIG. 4. As shown in FIGS. 3 and 4, the driving plate 26 has a center hole 78 formed therein coaxially with the rotation axis C, and is fastened to the crankshaft 14 with a plurality of bolts 82 such that the center hole 78 is held in engagement with a boss 80 which is formed on an end face of the crankshaft 14, coaxially with the rotation axis C. The driving plate 26 is also fastened with a plurality of bolts 86 at a radially outer portion thereof to a covering member 84 of the torque converter 16. The driving plate 26 has a short cylindrical portion 26a formed at its radially outer periphery so as to extend in a direction away from the torque converter 16. The driving plate 26 and the covering member 84 are rotary members provided rotatably with the crankshaft 14.

For example, the starter ring gear 44 is manufactured by bending a drawn rod member into an annular shape, butt-welding the rod member at its opposite end faces so as to form an annular member, forming the external teeth 44a to be parallel to the center line C on the outer circumferential surface of the annular member by using a tooth cutting tool such as a hob, and subjecting the external teeth 44a to a high-frequency or induction hardening treatment. The thus manufactured starter ring gear 44 is fixed at a plurality of positions to the driving plate 26 by MIG welding (metal inert gas welding), for instance, such that the starter ring gear 44 is fitted on the outer circumferential surface of the short cylindrical portion 26a, as shown in FIGS. 3-5. In the present embodiment, the starter ring gear 44 is welded on its side surface 90 opposite to its side surface 88 facing toward the above-described pinion gear 46a placed in the above-indicated non-meshing position, in the direction parallel to the rotation axis C, such that the starter ring gear 44 is welded to the driving plate 26 at four positions equally spaced apart from each other in the circumferential direction about the rotation axis C. Welding portions in the form of weld beads 92 between the starter ring gear 44 and the driving plate 26 are shown in FIGS. 3-5.

As shown in FIGS. 4 and 5, the starter ring gear 44 has a plurality of (four in this embodiment) arcuate grooves 94 formed in a radial portion between its inner circumferential surface and peak surfaces of its external teeth 44a, and radially outwardly of the weld beads 92, i.e. welding portions, between the starter ring gear 44 and the driving plate 26, such that the arcuate grooves 94 have a circumferential length larger than that of the weld beads 92. These plurality of arcuate grooves 94 are formed in the side surface 90, so as to extend in the circumferential direction, as a thermal resistor portion functioning to restrain conduction or transfer of a heat generated during welding between the starter ring gear 44 and the driving plate 26, to the external teeth 44a.

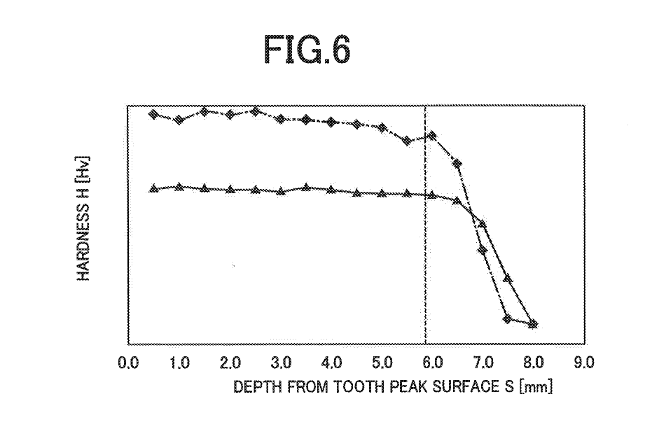

FIG. 6 is the view indicating the relationships between the hardness value (Vickers hardness) H[Hv] of the starter ring gear 44 and a distance S[mm] in a radial direction from the peak surfaces of the external teeth 44a of the starter ring gear 44 at a position in its direction of thickness 0.5 [mm] spaced from the side surface 88 as indicated in FIG. 5, at respective two circumferential positions of the starter ring gear 44 formed as described above. In FIG. 6, a solid line indicates the relationship of the external tooth 44a associated with the cross sectional line V-V in FIG. 4, while a one-dot chain line indicates the relationship of the external tooth 44a indicated by an arrow “d” in FIG. 4. It is noted that the relationships of FIG. 6 were obtained by experimentation.

On the other hand, FIG. 11 is the view indicating the relationships between the hardness value (Vickers hardness) H[Hv] of a prior art starter ring gear 44 and the distance S[mm] in the radial direction from peak surfaces of the external teeth 44a of the prior art starter ring gear at a position in its direction of thickness 0.5 [mm] spaced from the side surface 88, at the respective two circumferential positions of the prior art starter ring gear, the prior art starter gear being identical with the starter ring gear 44 according to the present embodiment, except for absence of a plurality of arcuate grooves 94 provided in the first embodiment. In FIG. 11, a solid line indicates the relationship of the external tooth 44a of the prior art starter ring gear which is located radially outwardly of one of the welding portions between this starter ring gear and the above-described driving plate 26, while a one-dot chain line indicates the relationship of the external tooth 44a not located radially outwardly of any of the welding portions. It is noted that the relationships of FIG. 11 were obtained by experimentation.

It will be understood from FIGS. 6 and 11 that both of the present starter ring gear 44 and the prior art starter ring gear have the same tendency that the hardness value H of the external tooth 44a located radially outwardly of the welding portion adjacent to the driving plate 26 is lower than that of the external tooth 44a not located radially outwardly of the welding portion. This tendency is considered to be caused by annealing of the external teeth 44a located radially outwardly of the welding portions, due to the heat generated during welding to the driving plate 26 and conducted to those external teeth 44a. However, the hardness value H of the external tooth 44a of the present starter ring gear 44 located radially outwardly of the welding portion, which hardness value H is indicated by the solid line in FIG. 6, is higher than that of the external tooth 44a of the prior art starter ring gear located radially outwardly of the welding portion indicated by the solid line in FIG. 11, at relatively small depths from the peak surfaces of the external teeth 44a. The higher hardness value H of the external tooth 44a of the present starter ring gear 44 is obtained owing to the presence of the arcuate grooves 94 which are provided in the radial portion between the external teeth 44a and the welding portions adjacent to the driving plate 26, and which restrain the conduction or transfer of the head generated during welding to the driving plate 26, to the external teeth 44a located radially outwardly of the welding portions, so that the external teeth 44a are less susceptible to annealing by the heat conducted thereto. Described more specifically, it is considered that the hardness value H of the external teeth 44a of the present starter ring gear 44 located radially outwardly of the welding portions adjacent to the driving plate 26 is made higher than that in the prior art starter ring gear, owing to not only a longer path of conduction of the heat generated during welding to the driving plate 26 detouring the arcuate groove 94, to the external teeth 44a in the presence of the arcuate grooves 94 in the radial portion between the external teeth 44a and the welding portions adjacent to the driving plate 26, but also a larger area of heat radiating surface and an accordingly smaller amount of the heat conducted to the external teeth 44a, than in the prior art not provided with the arcuate grooves 94.

As described above, the starter ring gear 44 according to the present embodiment has the plurality of arcuate grooves 94 which are formed in a radial portion of the side surface 90 between the inner circumferential surface and the peak surfaces of the external teeth 44a, so as to extend in the circumferential direction and radially outwardly of the plurality of welding portions in the form of the weld beads 92 adjacent to the driving plate (disc member) 26, such that the arcuate grooves 94 have the circumferential length larger than that of the weld beads 92, so that the arcuate grooves 94 function as a thermal resistor portion for restraining the conduction of the heat generated during welding to the driving plate 26, to the external teeth 44a. When the starter ring gear 44 the external teeth 44a of which are hardened by the induction hardening treatment is welded to the driving plate 26 such that the starter ring gear 44 is fitted on the outer circumferential surface of the driving plate 26, the arcuate grooves 94 restrain the conduction of the heat generated during welding to the driving plate 26, to the external teeth 44a, and accordingly restrain the degree of annealing of the external teeth 44a by the heat conducted thereto, making it possible to restrain reduction of the hardness of the external teeth 44a located adjacent to the welding portions, which reduction is caused by the welding to the driving plate 26. Accordingly, the provision of the arcuate grooves 94 makes it possible to restrain circumferentially local wearing of the external teeth 44a due to meshing engagement with the pinion gear 46a.

Further, the starter ring gear 44 of the present embodiment is provided in the engine starting device 42 provided with the automatic engine stop/start control means 76 for implementing the automatic engine stop/start control for automatically temporarily stopping the engine 10 when the vehicle running is stopped, and re-starting the engine 10 by operating the starter motor 46 of the engine starting device 42 to rotate the starter ring gear 44, when the vehicle running is re-started. As a result of implementation of this automatic engine stop/start control, the frequency of engine starting operations is made considerably higher, than in the case where the automatic engine stop/start control is not implemented, so that the starter ring gear 44 is required to have an accordingly increased degree of durability. In this respect, a comparatively simple modification of the starter ring gear 44 so as to form the plurality of arcuate grooves 94 in the side surface 90 makes it possible to increase the durability of the external teeth 44a of the starter ring gear 44.

It is noted that the external teeth of the starter ring gear provided in the conventional engine starting device, which is configured to bring the pinion gear of the starter motor into meshing engagement with the external teeth of the starter ring gear only when the engine is started, is required to have an increased degree of durability due to the above-indicated higher frequency of the engine starting operations, which accordingly increases the frequency of meshing contact of the starter ring gear with the external teeth of the pinion gear during a movement of the pinion gear toward the starter ring gear for meshing engagement of the pinion gear with the external teeth of the starter ring gear. It is considered that the durability of the starter ring gear required to withstand its meshing contact with the pinion gear can be reduced where the starter ring gear is of a permanent meshing type in which a permanent meshing clutch is provided between the starter motor and the starter ring gear. However, this solution undesirably requires modifications of not only the ring gear but also many components surrounding the ring gear.

### Second Embodiment

Other embodiments of this invention will be described. In the following descriptions, the same reference signs will be used to identify the same elements of the different embodiments, which will not be described.

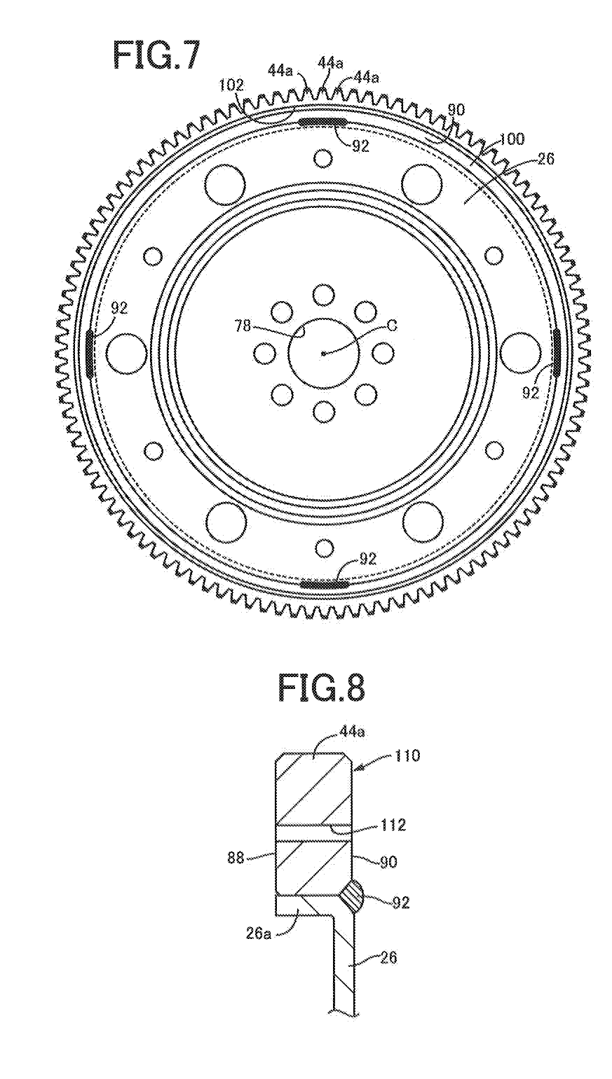

FIG. 7 is the view corresponding to that of FIG. 4 of the first embodiment, and showing a starter ring gear 100 according to another embodiment of the invention, and the driving plate 26. As shown in FIG. 7, the starter ring gear 100 is identical with the starter ring gear 44 of the first embodiment, except in that the arcuate grooves 94 are replaced by an annular groove 102 formed in a radial portion of the side surface 90 between the inner circumferential surface and the peak surfaces of the external teeth 44a of the starter ring gear 100, and radially outwardly of the plurality of welding portions in the form of weld beads 92 between the starter ring gear 100 and the driving plate 26, such that the annular groove 102 is formed continuously over the entire circumference of the starter ring gear 100. The annular groove 102 has the same cross sectional shape as the arcuate grooves 94 of the first embodiment shown in FIG. 5.

The starter ring gear 100 according to the present embodiment has the annular groove 102 which is formed in a radial portion of the side surface 90 between the inner circumferential surface and the peak surfaces of the external teeth 44a, so as to extend continuously over the entire circumference, and radially outwardly of the plurality of welding portions in the form of the weld beads 92 adjacent to the driving plate 26, so that the annular groove 102 functions as a thermal resistor portion for restraining the conduction of the heat generated during welding to the driving plate 26, to the external teeth 44a. When the starter ring gear 100 the external teeth 44a of which are hardened by the induction hardening treatment is welded to the driving plate 26 such that the starter ring gear 100 is fitted on the outer circumferential surface of the driving plate 26, the annular groove 102 restrains the conduction of the heat generated during welding to the driving plate 26, to the external teeth 44a, and accordingly restrains the degree of annealing of the external teeth 44a by the heat conducted thereto, making it possible to restrain reduction of the hardness of the external teeth 44a located adjacent to the welding portions, which reduction is caused by the welding to the driving plate 26, as in the first embodiment.

The annular groove 102 formed continuously over the entire circumference of the starter ring gear 100 of the present embodiment is advantageously easier to be cut than the arcuate grooves 94 formed over respective circumferential portions of the starter ring gear, so that the starter ring gear 100 can be manufactured at a reduced cost, and with a reduced weight.

The starter ring gear 44 of the first embodiment must be positioned in its circumferential direction such that the arcuate grooves 94 are aligned with the respective welding portions to be formed between the starter ring gear 44 and the driving plate 26, in the circumferential direction of the starter ring gear 44, when the starter ring gear 44 is fitted on the outer circumferential surface of the driving plate 26. Alternatively, the starter ring gear 44 and the driving plate 26 must be welded together; at their circumferential portions or positions aligned with the respective arcuate grooves 94 in the circumferential direction. However, the starter ring gear 100 of the present embodiment does not require the above-described positioning upon the welding operation or the determination of the welding positions, so that the number of steps required to manufacture the starter ring gear 100 is reduced, and the cost of manufacture of the starter ring gear 100 can be accordingly reduced.

### Third Embodiment

FIG. 8 is the view corresponding to that of FIG. 5 showing the first embodiment, and showing a starter ring gear 110 according to a further embodiment of the invention, and the driving plate 26. As shown in FIG. 8, the starter ring gear 110 is identical with the starter ring gear 44 of the first embodiment, except in that the arcuate grooves 94 are replaced by a plurality of (four in this embodiment) through-holes 112 formed in a radial portion between the inner circumferential surface and the peak surfaces of the external teeth 44a of the starter ring gear 110, so as to extend between its opposite side surfaces 88, 90, and radially outwardly of the plurality of welding portions in the form of weld beads 92 between the starter ring gear 110 and the driving plate 26, such that the through-holes 112 have a circumferential length larger than that of the weld beads 92. The circumferential positions at which these through-holes 112 are formed are the same as those of the arcuate grooves 94 indicated in FIG. 4.

The starter ring gear 110 according to the present embodiment has the plurality of through-holes 112 which are formed in a radial portion between the inner circumferential surface and the peak surfaces of the external teeth 44a, so as to extend between the opposite side surfaces 88, 90, and radially outwardly of the plurality of welding portions in the form of the weld beads 92 adjacent to the driving plate 26, so that the through-holes 112 function as a thermal resistor portion for restraining the conduction of the heat generated during welding to the driving plate 26, to the external teeth 44a. When the starter ring gear 44 the external teeth 44a of which are hardened by the induction hardening treatment is welded to the driving plate 26 such that the starter ring gear 44 is fitted on the outer circumferential surface of the driving plate 26, the through-holes 112 restrain the conduction of the heat generated during welding to the driving plate 26, to the external teeth 44a, and accordingly restrain the degree of annealing of the external teeth 44a by the heat conducted thereto, making it possible to restrain reduction of the hardness of the external teeth 44a located adjacent to the welding portions, which reduction is caused by the welding to the driving plate 26, as in the first embodiment.

### Fourth Embodiment

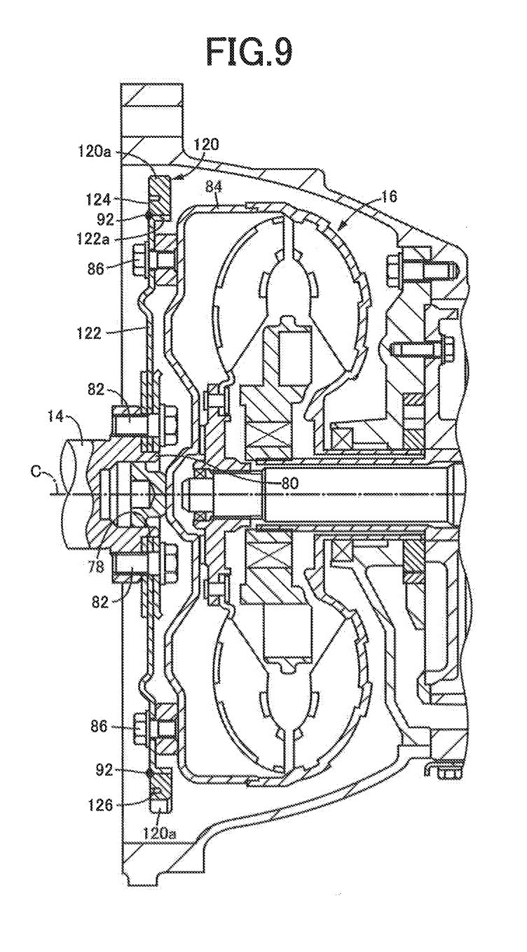

FIG. 9 is the view corresponding to that of FIG. 3 showing the first embodiment, and showing a starter ring gear 120 according to a still further embodiment of the invention, and a driving plate 122. As shown in FIG. 9, the driving plate 122 has a short cylindrical portion 122a formed at its radially outer periphery so as to extend in a direction toward the torque converter 16. The starter ring gear 120 is fixed at a plurality of positions to the driving plate 122 by MIG welding (metal inert gas welding), for instance, such that the starter ring gear 120 is fitted on the outer circumferential surface of the short cylindrical portion 122a. In the present embodiment, the starter ring gear 120 is welded on its side surface 124 facing the above-described pinion gear 46a placed in the above-indicated non-meshing position, in the direction parallel to the rotation axis C, such that the starter ring gear 120 is welded to the driving plate 122 at four positions equally spaced apart from each other in the circumferential direction about the rotation axis C. When the starter ring gear 120 is rotated by the above-described starter motor 46 same as in the embodiment 1, the above-described pinion gear 46a is moved by the above-described magnet switch 48 to the meshing position for meshing engagement with the starter ring gear 120. When the starter ring gear 120 is not rotated by the starter motor 46, the pinion gear 46a is moved to the non-meshing position for disengagement from the starter ring gear 120.

The starter ring gear 120 has a plurality of (four in this embodiment) arcuate grooves 126 formed in a radial portion between its inner circumferential surface and peak surfaces of its external teeth 120a, and radially outwardly of the welding portions in the form of the weld beads 92 between the starter ring gear 120 and the driving plate 122, such that the arcuate grooves 94 have a circumferential length larger than that of the weld beads 92. These plurality of arcuate grooves 126 are formed in the side surface 124 facing the above-described pinion gear 46a placed in the above-indicated non-meshing position, in the direction parallel to the rotation axis C, so as to extend in the circumferential direction, as a thermal resistor portion functioning to restrain conduction or transfer of a heat generated during welding between the starter ring gear 120 and the driving plate 122, to the external teeth 120a.

As in the first embodiment, due to the starter ring gear 120 of the present embodiment, the pinion gear 46a is moved to the meshing position for meshing engagement with the present starter ring gear 120 when the starter ring gear 120 is rotated by the starter motor 46, and to the non-meshing position for disengagement from the starter ring gear 120 when the starter ring gear 120 is not rotated by the starter motor 46. The starter ring gear 120 is welded to the driving plate 122 on one of its opposite side surfaces, namely, on the side surface 124 which faces the pinion gear 46a placed in the above-described non-meshing position, in the direction parallel to the rotation axis C, and the arcuate grooves 126 functioning as the thermal resistor portion are formed in the above-indicated side surface 124, to restrain conduction of the heat generated during welding between the starter ring gear 120 and the driving plate 122, particularly to those parts of the external teeth 120a of the starter ring gear 120 which parts are located on the side of the side surface 124 and which contact with the pinion gear 46a moved from the above-indicated non-meshing position to the above-indicated meshing position. Accordingly, the arcuate grooves 126 can restrain hardness reduction of the above-indicated parts of the external teeth 120a on the side of the side surface 124, which parts are particularly required to have a high degree of hardness.

While the embodiments of this invention have been described above in detail by reference to the drawings, it is to be understood that this invention is not limited to the details of the illustrated embodiments, but may be otherwise embodied.

For example, the illustrated embodiments are configured such that the illustrated starter ring gear 44 (100, 110, 120) is provided with the thermal resistor portion in the form of the arcuate grooves 94 (126), annular groove 102 or through-holes 112 formed radially outwardly of the welding portions, to restrain conduction of the heat generated during welding to the driving plate 26 (122) to the external teeth 44a. However, the starter ring gear may be provided with a member which is formed of a heat-resistant region or other material having a low degree of thermal conductivity and which is located radially outwardly of each welding portion, for example. For instance, the starter ring gear may consist of three layers superposed on and bonded to each other in the radial direction, more specifically, an inner metallic annular member, an intermediate annular member formed of a heat-resistant resin, and an outer metallic annular member having outer teeth which are formed on its outer circumferential surface and which are engageable with the pinion gear of the starter motor. In this case, the intermediate annular member formed of the heat-resistant resin can restrain conduction of the heat generated during welding between the radially inner portion of the above-indicated inner metallic annular member and the driving plate 26, to the external teeth of the above-indicated outer metallic annular member.

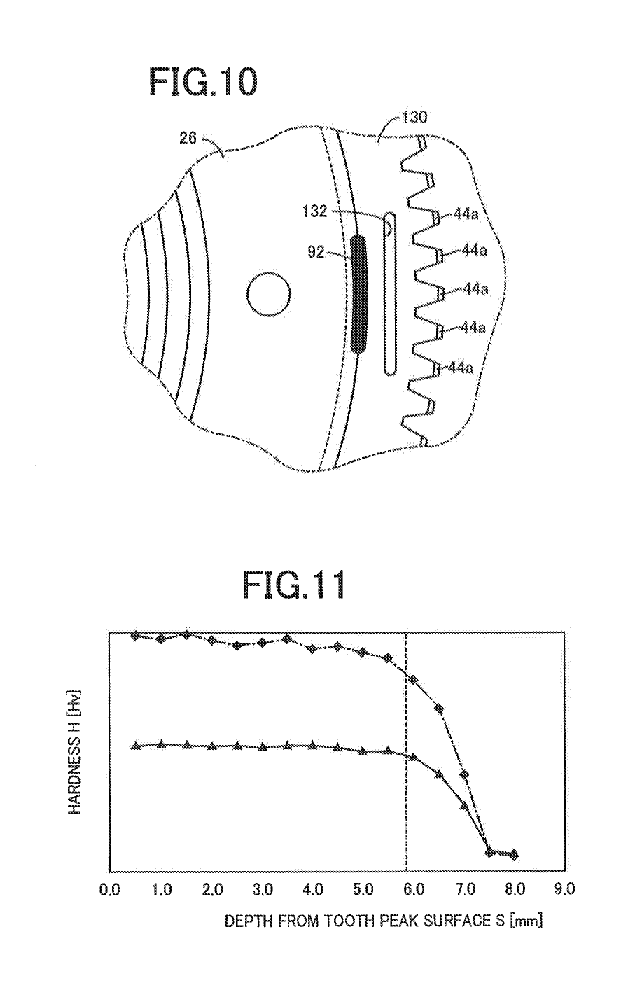

The first embodiment is configured such that the starter ring gear 44 is provided with the thermal resistor portion in the form of the arcuate grooves 94 formed radially outwardly of the welding portions so as to extend in the circumferential direction on the side surface of the starter ring gear 44, for restraining conduction of the heat generated during welding to the driving plate 26, to the external teeth 44a. However, the grooves formed in the starter ring gear may have any other shapes. An example of this modification is shown in FIG. 10 showing a circumferential portion of a starter ring gear 130, which has a thermal resistor portion in the form of straight grooves 132 formed in one of its opposite side surfaces, and radially outwardly of respective welding portions, such that each straight groove 132 extends in a tangential direction.

The illustrated embodiments are also configured such that the starter ring gear 44 (100, 110, 120) is welded to the driving plate 26 (122) by MIG welding (metal inert gas welding). However, the starter ring gear may be welded to the driving plate by laser welding or any other welding method.

The illustrated embodiments are further configured such that the starter ring gear 44 (100, 110, 120) is welded to the driving plate 26 (122) at four positions equally spaced apart from each other in the circumferential direction about the rotation axis C. However, the welding positions need not be equally spaced apart from each other, and need not be limited to the four positions and may be six or twelve positions.

The illustrated embodiments are also configured such that the starter ring gear 44 (100, 110, 120) is welded to the driving plate 26 (122). However, the starter ring gear may be welding to the covering member 84 of the torque converter 16, or to any other member rotated with the crankshaft 14 of the engine 10.

Although the arcuate grooves 94 (126) and the through-holes 112 formed radially outwardly of the plurality of welding portions in the form of the weld beads 92 between the starter ring gear 44 (110) and the driving plate 26 have the circumferential length larger than that of the weld beads 92, the circumferential length of those grooves and through-holes need not be larger than that of the weld beads 92.

Further, the arcuate grooves 94 (126) and the through-holes 112 need not be provided such that each of these grooves and though-holes is located radially outwardly of a corresponding one of the weld beads 92. For instance, a plurality of arcuate grooves or through-holes may be provided radially outwardly of each of the weld beads 92 such that those arcuate grooves or through-holes are formed radially outwardly and inwardly of each other, or spaced apart from each other in the circumferential direction.

Further, the arcuate grooves 94 (126) and the annular groove 102 need not be formed in only one of the opposite side surfaces, but may be formed in both of the opposite side surfaces.

While the engine starting device 42 is configured such that the pinion gear 46a of its starter motor 46 is brought into meshing engagement with the starter ring gear 44 (100, 110, 120) only when the engine is started, the engine starting device may be of any other type, such as a permanent meshing type ring gear in which a permanent meshing clutch is provided between the starter motor 46 and the starter ring gear 44.

The illustrated embodiments are further configured such that the starter ring gear 44 (100, 110, 120) is provided in the power transmitting system 12 provided with the automatic transmission 18 of a planetary gear type. However, the starter ring gear may be provided in a power transmitting system provided with any other type of transmission such as a continuously variable transmission, or a permanent meshing type transmission incorporating automatic clutches.

It is to be understood that the embodiments of the present invention have been described for illustrative purpose only, and that the invention may be embodied with various other changes and improvements not illustrated herein, which may occur to those skilled in the art, without departing from the spirit of the invention.

### NOMENCLATURE OF REFERENCE SIGNS

10: Engine

26: Driving plate (Disc member)

44: Starter ring gear (Vehicular starter ring gear)

44a: External teeth

46: Starter motor

46a: Pinion gear

88, 124: One side surface

90: Other side surface

92: Weld beads (Welding portions)

94, 126: Arcuate grooves (Thermal resistor portion)

102: Annular groove (Thermal resistor portion)

112: Through-holes (Thermal resistor portion)

C: Axis of rotation

1. A vehicular starter ring gear in the form of an annular member which has external teeth and which is welded at a plurality of positions to a disc member rotated with an engine, such that the vehicular starter ring gear is fitted on an outer circumferential surface of said disc member, so that the vehicular starter ring gear is rotated to start said engine, by a starter motor having a pinion gear engageable with said external teeth, comprising:
a thermal resistor portion provided in a radial portion between an inner circumferential surface and peak surfaces of said external teeth, and radially outwardly of at least welding portions bridging said vehicular starter ring gear and said disc member, said thermal resistor portion restraining conduction of a heat generated during an operation to form said welding portions, to said external teeth.

2. The vehicular starter ring gear according to claim 1, wherein said thermal resistor portion consists of an arcuate groove formed in a side surface of said vehicular starter ring gear, so as to extend in a circumferential direction of the vehicular starter ring gear, or a straight groove formed in said side surface, so as to extend in a tangential direction of the vehicular starter ring gear.

3. The vehicular starter ring gear according to claim 1, wherein said thermal resistor portion consists of an annular groove formed in a side surface of said vehicular starter ring gear, continuously over an entire circumference of the vehicular starter ring gear.

4. The vehicular starter ring gear according to claim 1, wherein said thermal resistor portion consists of a through-hole formed between opposite side surfaces of said vehicular starter ring gear.

5. The vehicular starter ring gear according to claim 2, wherein said pinion gear is movable in a direction parallel to an axis of rotation of said vehicular starter ring gear, between a meshing position for meshing engagement with said vehicular starter ring gear, and a non-meshing position for disengagement from said vehicular starter ring gear, and is moved to said meshing position when said vehicular starter ring gear is rotated by said starter motor, and to said non-meshing position when said vehicular starter ring gear is not rotated by said starter motor,
and wherein said thermal resistor portion is formed in one of opposite side surfaces of said vehicular starter ring gear which faces toward said pinion gear placed in said non-meshing position, in the direction parallel to said axis of rotation, and on which the vehicular starter ring gear is welded to said disc member.

6. (canceled)

7. The vehicular starter ring gear according to claim 3, wherein said pinion gear is movable in a direction parallel to an axis of rotation of said vehicular starter ring gear, between a meshing position for meshing engagement with said vehicular starter ring gear, and a non-meshing position for disengagement from said vehicular starter ring gear, and is moved to said meshing position when said vehicular starter ring gear is rotated by said starter motor, and to said non-meshing position when said vehicular starter ring gear is not rotated by said starter motor,
and wherein said thermal resistor portion is formed in one of opposite side surfaces of said vehicular starter ring gear which faces toward said pinion gear placed in said non-meshing position, in the direction parallel to said axis of rotation, and on which the vehicular starter ring gear is welded to said disc member.

8. The vehicular starter ring gear according to claim 1, wherein said vehicular starter ring gear is rotated by said starter motor to re-start said engine, as a part of an automatic engine stop/start control wherein said engine is automatically temporarily stopped when a running of a vehicle is stopped, and is automatically re-started when the running of the vehicle is re-started.
